(19) United States
(12) Patent Application Publication
(10) Pub. No.: US 2010/0190502 A1
(43) Pub. Date: Jul. 29, 2010

(54) METHODS AND SYSSTEMS FOR NETWORK ASSISTED SYSTEM ACQUISITION

(75) Inventors: Shan Qing, San Diego, CA (US); Carl Guangming Shi, San Diego, CA (US); Tom Chin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/358,996

(22) Filed: Jan. 23, 2009

(51) Int. Cl. H04W 40/00

(52) U.S. Cl. 455/445

(57) ABSTRACT

Certain embodiments of the present disclosure provide techniques for re-directing a mobile station to perform network re-entry through a neighbor base station. A current serving BS may re-direct the MS to a neighbor BS with a message containing configuration information allowing the MS to communicate with the target BS without a lengthy scan procedure.

### TECHNICAL FIELD

Certain embodiments of the present disclosure generally relate to wireless communication and, more particularly, to mobile station system acquisition.

### SUMMARY

Certain embodiments provide a method for assisting, by a base station (BS), with network acquisition by a mobile station (MS). The method generally includes obtaining configuration information for one or more neighbor base stations that are candidate target base stations, detecting a situation that warrants redirecting the MS to perform network entry through one of the neighbor target BSs, and transmitting a message redirecting the MS to perform network acquisition with the target BS and including configuration information for the target BS.

Certain embodiments provide a method for performing network acquisition by a mobile station (MS). The method generally includes receiving a message, from a current BS, redirecting the MS to perform network acquisition with a target BS, extracting configuration information for the target BS from the message, and performing network acquisition with the target BS using the configuration information for the neighbor BS extracted from the message.

Certain embodiments provide an apparatus for assisting, by a base station (BS), with network acquisition by a mobile station (MS). The apparatus generally includes logic for obtaining configuration information for one or more neighbor base stations that are candidate target base stations, logic for detecting a situation that warrants redirecting the MS to perform network entry through one of the neighbor target BSs, and logic for transmitting a message redirecting the MS to perform network acquisition with the target BS and including configuration information for the target BS.

Certain embodiments provide an apparatus for performing network acquisition by a mobile station (MS). The apparatus generally includes logic for receiving a message, from a current BS, redirecting the MS to perform network acquisition with a target BS, logic for extracting configuration information for the target BS from the message, and logic for performing network acquisition with the target BS using the configuration information for the neighbor BS extracted from the message.

Certain embodiments provide an apparatus for assisting, by a base station (BS), with network acquisition by a mobile station (MS). The apparatus generally includes means for obtaining configuration information for one or more neighbor base stations that are candidate target base stations, means for detecting a situation that warrants redirecting the MS to perform network entry through one of the neighbor target BSs, and means for transmitting a message redirecting the MS to perform network acquisition with the target BS and including configuration information for the target BS.

Certain embodiments provide an apparatus for performing network acquisition by a mobile station (MS). The apparatus generally includes means for receiving a message, from a current BS, redirecting the MS to perform network acquisition with a target BS, means for extracting configuration information for the target BS from the message, and means for performing network acquisition with the target BS using the configuration information for the neighbor BS extracted from the message.

Certain embodiments provide a computer-program product for assisting, by a base station (BS), with network acquisition by a mobile station (MS), comprising a computer readable medium having instructions stored thereon, the instructions being executable by one or more processors. The instructions generally include instructions for obtaining configuration information for one or more neighbor base stations that are candidate target base stations, instructions for detecting a situation that warrants redirecting the MS to perform network entry through one of the neighbor target BSs, and instructions for transmitting a message redirecting the MS to perform network acquisition with the target BS and including configuration information for the target BS.

Certain embodiments provide a computer-program product for performing network acquisition by a mobile station (MS), comprising a computer readable medium having instructions stored thereon, the instructions being executable by one or more processors. The instructions generally include instructions for receiving a message, from a current BS, redirecting the MS to perform network acquisition with a target BS, instructions for extracting configuration information for the target BS from the message, and instructions for performing network acquisition with the target BS using the configuration information for the neighbor BS extracted from the message.

In certain embodiments, as presented above, the message containing the configuration information for the target BS is transmitted in accordance with one or more standards of the Institute of Electrical and Electronics Engineers (IEEE) 802.16 family of standards.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates example operations for re-directing an MS to perform network entry with a TARGET BS, in accordance with certain embodiments of the present disclosure.

FIG. 4A is a block diagram of means corresponding to the example operations of FIG. 4.

FIG. 5 illustrates example operations for re-directing an MS to perform network entry with a TARGET BS, in accordance with certain embodiments of the present disclosure.

FIG. 5A is a block diagram of means corresponding to the example operations of FIG. 5.

FIG. 6 illustrates example exchanges between a mobile station and two base stations utilizing a base station re-direct TLV, in accordance with certain aspects of the present disclosure.

FIG. 7 illustrates example exchanges between a mobile station and two base stations utilizing a base station re-direct MAC message, in accordance with certain aspects of the present disclosure.

### DETAILED DESCRIPTION

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

In a Mobile WiMAX system, a mobile station performs initial network acquisition after powering up. One important performance metric for a mobile station relates to how long it takes the mobile station to detect and start receiving services from the network. Obviously, the faster the mobile station can acquire the network and begin receiving services, the better the user experience. During initial network acquisition, the mobile station searches for candidate base stations by scanning the WiMAX RF channel to detect the existence of preamble sent by a particular base station. Once a strong preamble is detected, the mobile station starts the network entry procedure with the corresponding base station.

Unfortunately, sometimes even when the mobile station is able to exchange MAC management messages (for example, RNG-REQ/RNG-RSP) with a detected base station, the network entry procedure can still fail due to various reasons, such as registration failure, basic capability negotiation failure, and authentication failure. When such failures occur, the mobile station needs to start a new network acquisition attempt, which results in additional delay before the MS can begin receiving network services and detracts from the user experience.

Embodiments of the present disclosure provide techniques in which a network may assist in MS system acquisition. By providing a mechanism for a serving BS to re-direct an MS to perform a network entry with a TARGET BS and providing configuration information for the TARGET BS, system acquisition time may be reduced and an MS may be able to begin service with the network sooner.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

WiMAX is one example of a communication system based on an orthogonal multiplexing scheme. As noted above, there are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

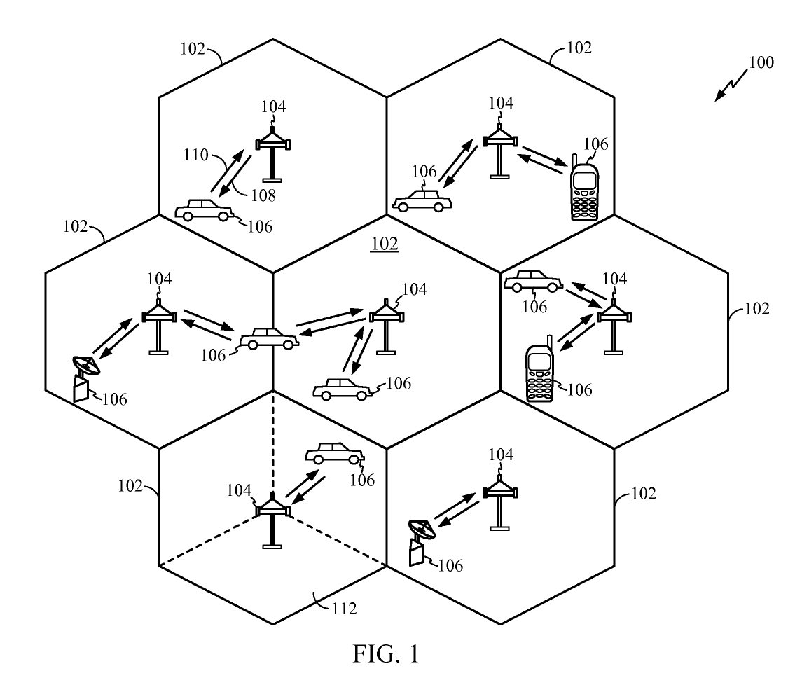

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

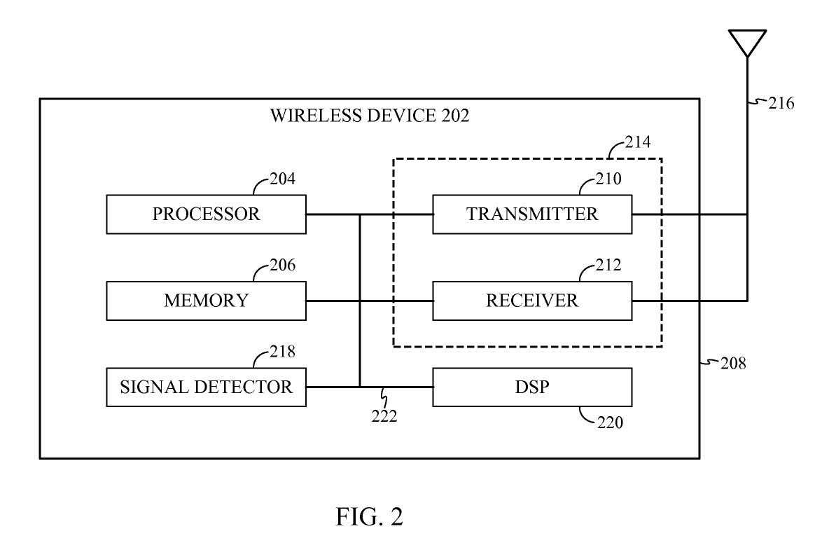

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

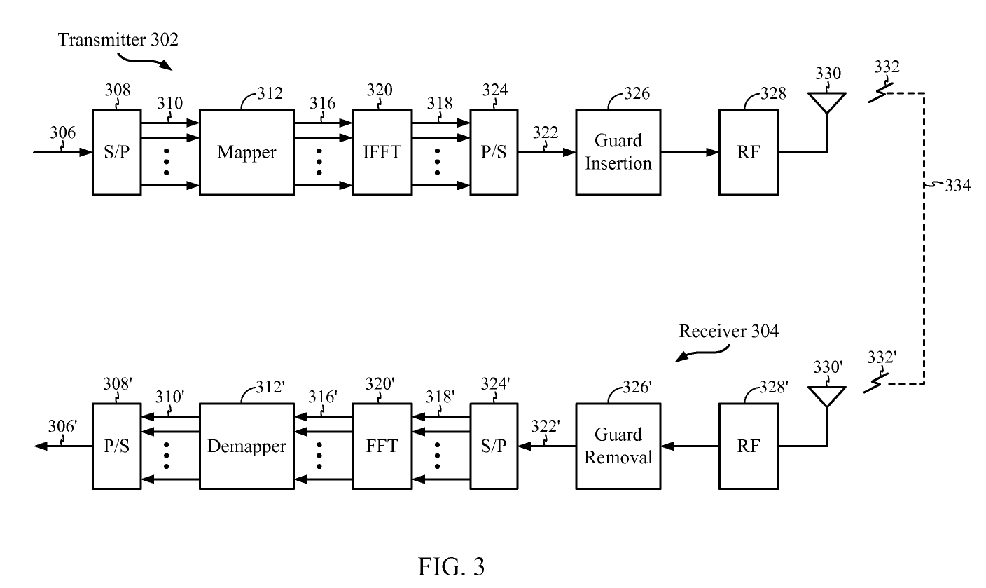

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found on a in a baseband processor 340′.

### Exemplary Network-Assisted System Acquisition

As previously mentioned, during initial network acquisition, the mobile station searches for candidate base stations by scanning the WiMAX RF channel to detect the existence of preamble sent by a particular base station and starts the network entry procedure with a base station once a strong preamble is detected. However, in the event that a failure occurs in the registration process, the mobile station needs to start a new network acquisition attempt, which results in additional delay before the MS can begin receiving network services and detracts from the user experience.

Embodiments of the present disclosure, however, may help reduce system acquisition time in the event of a failure during the registration process by providing a technique for the network to assist the MS with the registration process. For example, by providing the MS with configuration information about a candidate target BS, such as frequency index, preamble index, cyclic prefix, FFT size, bandwidth, and the like, the network may help the MS to shorten or avoid a lengthy scan process and quickly begin registration with the target BS.

In other words, the techniques presented herein may take advantage of the fact that a current BS in communication with the MS typically knows more about the status of its neighbor BSs (such as capability, QoS status, etc.) than the MS though the exchange of backbone messages. With the techniques presented herein, the network acquisition procedure of the MS may be guided by the BS, with the network helping the MS find and acquire a suitable BS faster, rather than having the MS stay in an iterative “try-fail-retry” cycle.

According to certain embodiments of the present disclosure, this configuration information may be provided in a MAC management message. The configuration information may be provided in a new MAC management message, intended for “base station re-direct” to guide an MS to a BS that may be more suitable for successful registration. As an alternative, or in addition to a dedicated BS redirect MAC management message, the BS configuration information may be included in a type-length-variable (TLV) in an existing MAC management message, such as a RNG-RSP, REG-RSP, SBC-RSP, or any other applicable WiMAX MAC management messages. In either case, when a network entry failure occurs, the current base station, may re-direct the mobile station to attempt network entry procedure with a different base station which will be specified in the new message and/or TLV.

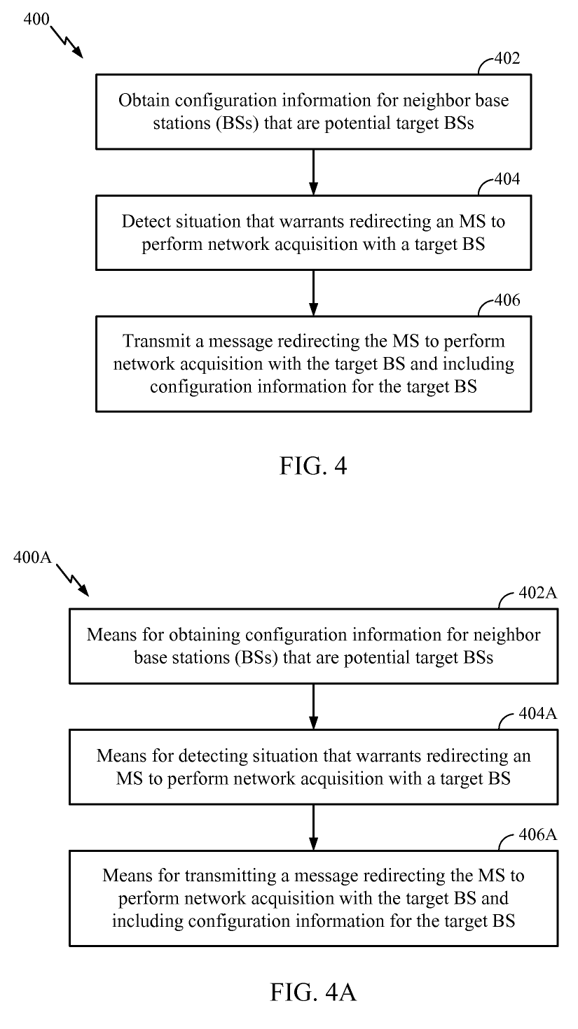

FIG. 4 illustrates example operations for re-directing an MS to perform network entry with a target BS, in accordance with certain embodiments of the present disclosure. The operations may be performed, for example, by a BS with which an attempted network registration has failed. In addition, the operations may be performed by a BS to re-direct the MS to a new base station in other situations, such as when the current BS is busy and can not provide the QoS that the mobile station needs and/or when the current BS is a test BS.

At 402, the BS obtains configuration information for neighbor base stations that are candidate target base stations. For example, a BS may obtain configuration information from neighbor BSs through an exchange of messages via a network backbone (e.g., a wired connection that allows communication between and management of BSs). This configuration information may include a variety of different type information that may assist a MS in acquiring the network through a targeted neighbor BS.

For example, the configuration information may include one or more of the following: frequency index, preamble index, cyclic prefix, FFT size, bandwidth, and the like. Such information may help the MS quickly detect a suitable BS for network acquisition without a lengthy sequential scan of all frequencies in order to detect a preamble with suitable signal strength. For certain embodiments, a current BS may determine that a suitable target BS is suitable to handle the particular needs (e.g., QoS of a MS seeking to enter the network). In this manner, targeted BSs to which an MS is re-directed may be pre-screened. This pre-screening may help avoid the scenario where MAC management messages are successfully exchanged with a target BS, only to have network acquisition with the BS later fail for some reason.

At 404, the BS detects a situation that warrants redirecting a MS to perform network acquisition with a neighbor BS. At 406, the BS transmits a message redirecting the MS to perform network acquisition with the neighbor BS and including configuration information for the neighbor BS. As previously noted, the BS may include the configuration information for a target BS in a dedicated (BS re-direct MAC management) message and/or as a BS re-direct TLV in an existing message.

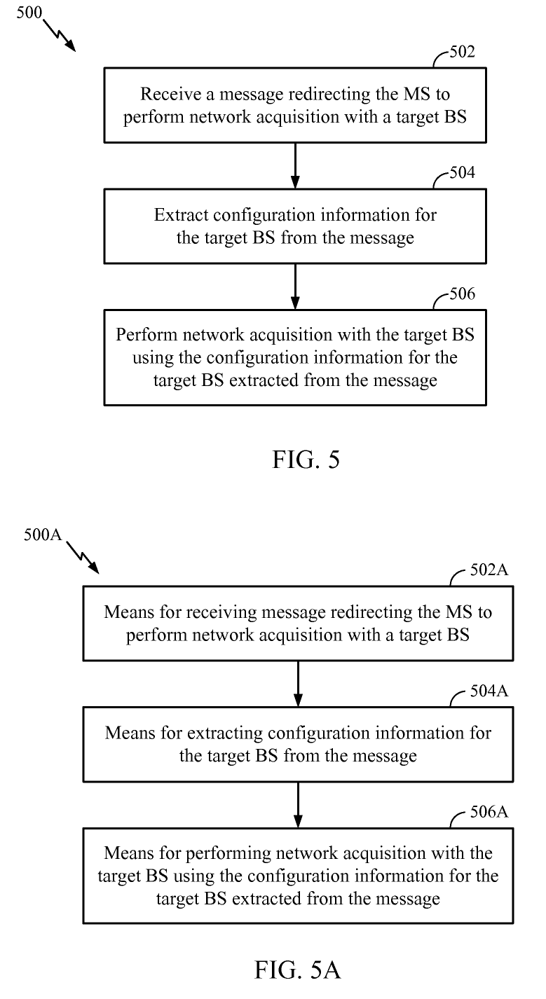

FIG. 5 illustrates example operations that may be performed at the MS, to perform network-assisted re-entry with a neighbor BS, in accordance with certain embodiments of the present disclosure. The operations may be performed, for example, while the MS is performing network acquisition or may be performed at any other time, for example, during normal data exchange in the event a current BS determines it is no longer suitable to support a set of services required by the MS.

At 502, the MS receives a message, from the current BS, redirecting the MS to perform network acquisition with a neighbor (target) BS. At 504, the MS extracts configuration information for the neighbor BS from the message. As previously described, the configuration information may include a variety of configuration information that may assist the MS in acquiring the network through the target BS. At 506, the MS performs network acquisition with the TARGET BS using the configuration information for the target BS extracted from the message.

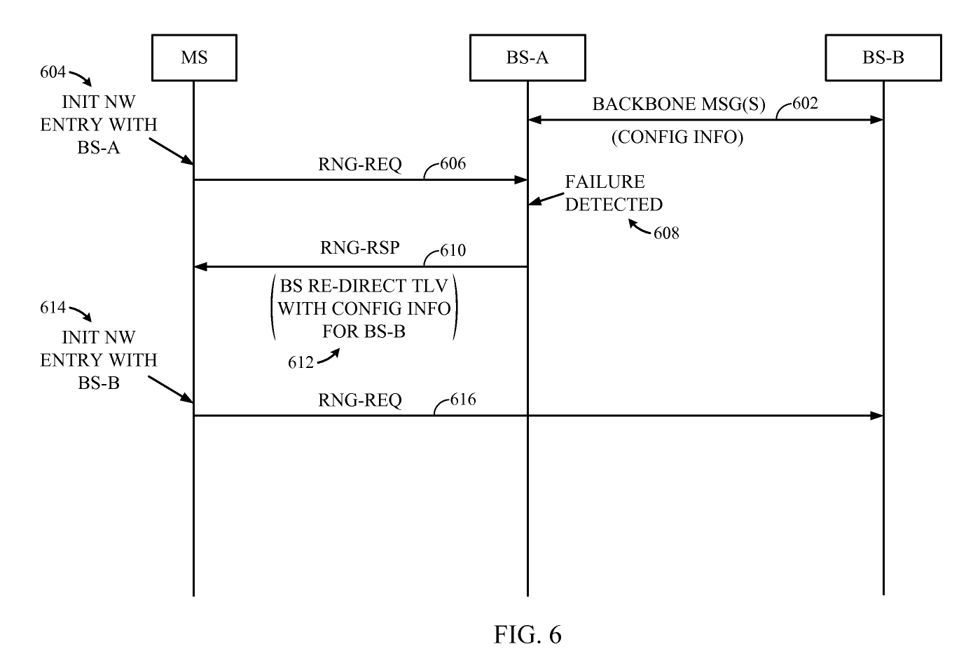

FIG. 6 illustrates example exchanges between a mobile station and two base stations utilizing a base station re-direct TLV, in accordance with certain aspects of the present disclosure. The illustrated example assumes BS-A is a current serving BS and that BS-B is a neighbor BS to which the MS is re-directed.

BS-A obtains configuration information for BS-B, for example, through the exchange of backbone messages, at 602. In this example, the MS initiates network entry through BS-A, at 604, with a range request (RNG-REQ) message 606. BS-A detects a failure in the network entry procedure, at 608. BS-A re-directs the MS to enter the network through BS-B by sending a ranging response (RNG-RSP) message, at 610, with a TLV 612 containing configuration information for BS-B. This configuration information allows the MS to promptly initiate network re-entry with BS-B, at 614. For example, the MS may be able to send a RNG-REQ to BS-B, without having to perform a lengthy scan for preambles of sufficient strength.

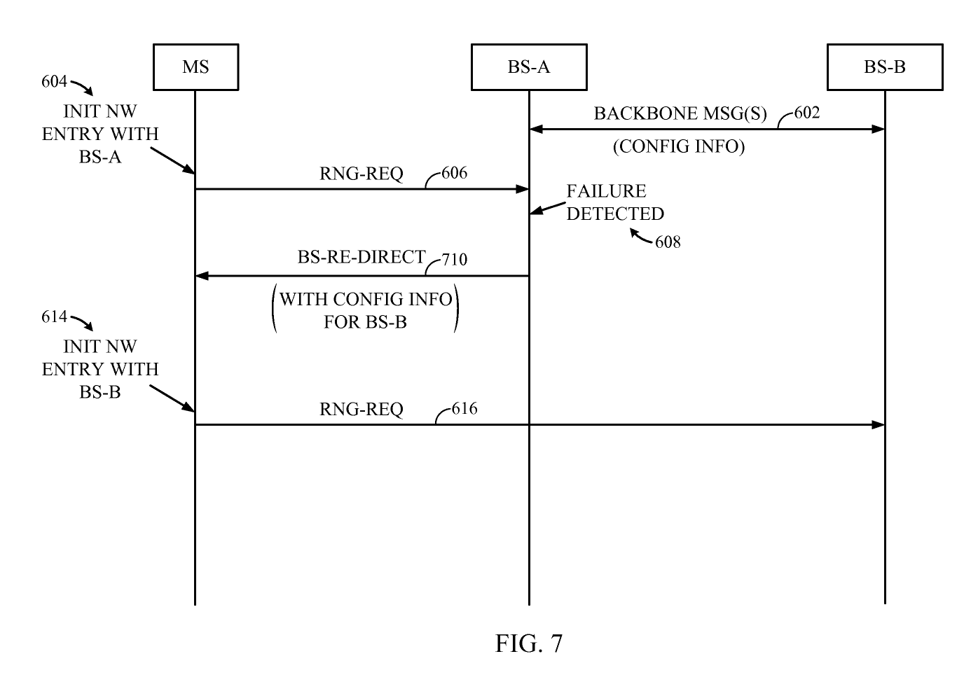

As illustrated in FIG. 7, for certain embodiments, BS-A may re-direct the MS to perform network entry through BS-B via a dedicated BS Re-direct (BS_REDIRECT) MAC management message, at 710. The MAC management message may include the same type of configuration information as the TLV 612 in FIG. 6, allowing the MS to promptly perform initiate network re-entry with BS-B, without having to perform a lengthy scan for preambles of sufficient strength.

While the examples illustrated in FIGS. 6 and 7 are directed to failures detected during network entry, a current BS may re-direct an MS to a different target BS in other situations, as well. For example, a current BS may re-direct the MS (via TLV or dedicated MAC management message) to a new BS in other situations, such as when the current BS is busy (loaded with traffic) and is unable to can not provide the QoS that the mobile station needs.

For certain embodiments, the current BS may provide the MS with configuration information for a set of target BSs that may be suitable candidates for network re-entry. Providing such a list of preferred BSs may still allow the MS to quickly initiate network re-entry, for example, after a short scan to pick which target BS has the best signal strength.

By taking advantage of the likelihood that a current BS has more knowledge of the status (such as capability, QoS status, and the like) of its neighbor BSs than a MS, the techniques presented herein may allow the current BS to guide the network acquisition procedure of the MS to help quickly acquire an appropriate BS.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, operations 400 illustrated in FIG. 4 correspond to means-plus-function blocks 400A illustrated in FIG. 4A. Similarly, operations 500 illustrated in FIG. 5 correspond to means-plus-function blocks 500A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to embodiments of the present disclosure, other and further embodiments of the disclosure may be devised without departing from the basic scope thereof, and the scope thereof is determined by the claims that follow.

What is claimed is:

1. A method for assisting, by a base station (BS), with network acquisition by a mobile station (MS), comprising:
obtaining configuration information for one or more neighbor base stations that are candidate target base stations;
detecting a situation that warrants redirecting the MS to perform network entry through one of the neighbor target BSs; and
transmitting a message redirecting the MS to perform network acquisition with the target BS and including configuration information for the target BS.

2. The method of claim 1, wherein detecting a situation that warrants redirecting the MS to perform network acquisition with a target BS comprises:
detecting the BS may not be able to satisfy quality of service (QoS) requirements for the MS.

3. The method of claim 1, wherein detecting a situation that warrants redirecting the MS to perform network acquisition with a target BS comprises:
detecting failure of a network entry procedure involving the MS.

4. The method of claim 1, wherein the configuration information comprises information allowing the MS to communicate with the target BS without scanning for a preamble.

5. The method of claim 1, wherein the configuration information comprises at least one of: a frequency index, a preamble index, a cyclic prefix, and a FFT size for the target BS.

6. The method of claim 1, wherein configuration information is contained as a TLV in the transmitted message.

7. The method of claim 1, wherein configuration information is contained in a BS re-direct MAC management message.

8. A method for performing network acquisition by a mobile station (MS), comprising:
receiving a message, from a current BS, redirecting the MS to perform network acquisition with a target BS;
extracting configuration information for the target BS from the message; and
performing network acquisition with the target BS using the configuration information for the neighbor BS extracted from the message.

9. The method of claim 8, wherein the message is received during a network entry procedure with the current BS.

10. The method of claim 8, wherein the message is received after successful network entry with the current BS.

11. The method of claim 8, wherein the configuration information comprises information allowing the MS to communicate with the target BS without scanning for a preamble.

12. The method of claim 8, wherein the configuration information comprises at least one of: a frequency index, a preamble index, a cyclic prefix, and a FFT size for the target BS.

13. The method of claim 8, wherein configuration information is contained as a TLV in the transmitted message.

14. The method of claim 8, wherein configuration information is contained in a BS re-direct MAC management message.

15. An apparatus for assisting, by a base station (BS), with network acquisition by a mobile station (MS), comprising:
logic for obtaining configuration information for one or more neighbor base stations that are candidate target base stations;
logic for detecting a situation that warrants redirecting the MS to perform network entry through one of the neighbor target BSs; and
logic for transmitting a message redirecting the MS to perform network acquisition with the target BS and including configuration information for the target BS.

16. The apparatus of claim 15, wherein the logic for detecting a situation that warrants redirecting the MS to perform network acquisition with a target BS comprises:
logic for detecting the BS may not be able to satisfy quality of service (QoS) requirements for the MS.

17. The apparatus of claim 15, wherein the logic for detecting a situation that warrants redirecting the MS to perform network acquisition with a target BS comprises:
logic for detecting failure of a network entry procedure involving the MS.

18. The apparatus of claim 15, wherein the configuration information comprises information allowing the MS to communicate with the target BS without scanning for a preamble.

19. The apparatus of claim 15, wherein the configuration information comprises at least one of: a frequency index, a preamble index, a cyclic prefix, and a FFT size for the target BS.

20. The apparatus of claim 15, wherein configuration information is contained as a TLV in the transmitted message.

21. The apparatus of claim 15, wherein configuration information is contained in a BS re-direct MAC management message.

22. An apparatus for performing network acquisition by a mobile station (MS), comprising:
logic for receiving a message, from a current BS, redirecting the MS to perform network acquisition with a target BS;
logic for extracting configuration information for the target BS from the message; and
logic for performing network acquisition with the target BS using the configuration information for the neighbor BS extracted from the message.

23. The apparatus of claim 22, wherein the message is received during a network entry procedure with the current BS.

24. The apparatus of claim 22, wherein the message is received after successful network entry with the current BS.

25. The apparatus of claim 22, wherein the configuration information comprises information allowing the MS to communicate with the target BS without scanning for a preamble.

26. The apparatus of claim 22, wherein the configuration information comprises at least one of: a frequency index, a preamble index, a cyclic prefix, and a FFT size for the target BS.

27. The apparatus of claim 22, wherein configuration information is contained as a TLV in the transmitted message.

28. The apparatus of claim 22, wherein configuration information is contained in a BS re-direct MAC management message.

29. An apparatus for assisting, by a base station (BS), with network acquisition by a mobile station (MS), comprising:
means for obtaining configuration information for one or more neighbor base stations that are candidate target base stations;
means for detecting a situation that warrants redirecting the MS to perform network entry through one of the neighbor target BSs; and
means for transmitting a message redirecting the MS to perform network acquisition with the target BS and including configuration information for the target BS.

30. The apparatus of claim 29, wherein the means for detecting a situation that warrants redirecting the MS to perform network acquisition with a target BS comprises:
means for detecting the BS may not be able to satisfy quality of service (QoS) requirements for the MS.

31. The apparatus of claim 29, wherein the means for detecting a situation that warrants redirecting the MS to perform network acquisition with a target BS comprises:
means for detecting failure of a network entry procedure involving the MS.

32. The apparatus of claim 29, wherein the configuration information comprises information allowing the MS to communicate with the target BS without scanning for a preamble.

33. The apparatus of claim 29, wherein the configuration information comprises at least one of: a frequency index, a preamble index, a cyclic prefix, and a FFT size for the target BS.

34. The apparatus of claim 29, wherein configuration information is contained as a TLV in the transmitted message.

35. The apparatus of claim 29, wherein configuration information is contained in a BS re-direct MAC management message.

36. An apparatus for performing network acquisition by a mobile station (MS), comprising:
means for receiving a message, from a current BS, redirecting the MS to perform network acquisition with a target BS;
means for extracting configuration information for the target BS from the message; and
means for performing network acquisition with the target BS using the configuration information for the neighbor BS extracted from the message.

37. The apparatus of claim 36, wherein the message is received during a network entry procedure with the current BS.

38. The apparatus of claim 36, wherein the message is received after successful network entry with the current BS.

39. The apparatus of claim 36, wherein the configuration information comprises information allowing the MS to communicate with the target BS without scanning for a preamble.

40. The apparatus of claim 36, wherein the configuration information comprises at least one of: a frequency index, a preamble index, a cyclic prefix, and a FFT size for the target BS.

41. The apparatus of claim 36, wherein configuration information is contained as a TLV in the transmitted message.

42. The apparatus of claim 36, wherein configuration information is contained in a BS re-direct MAC management message.

43. A computer-program product for assisting, by a base station (BS), with network acquisition by a mobile station (MS), comprising a computer readable medium having instructions stored thereon, the instructions being executable by one or more processors and the instructions comprising:
instructions for obtaining configuration information for one or more neighbor base stations that are candidate target base stations;
instructions for detecting a situation that warrants redirecting the MS to perform network entry through one of the neighbor target BSs; and
instructions for transmitting a message redirecting the MS to perform network acquisition with the target BS and including configuration information for the target BS.

44. The computer-program product of claim 43, wherein the instructions for detecting a situation that warrants redirecting the MS to perform network acquisition with a target BS comprise:
instructions for detecting the BS may not be able to satisfy quality of service (QoS) requirements for the MS.

45. The computer-program product of claim 43, wherein the instructions for detecting a situation that warrants redirecting the MS to perform network acquisition with a target BS comprise:
instructions for detecting failure of a network entry procedure involving the MS.

46. The computer-program product of claim 43, wherein the configuration information comprises information allowing the MS to communicate with the target BS without scanning for a preamble.

47. The computer-program product of claim 43, wherein the configuration information comprises at least one of: a frequency index, a preamble index, a cyclic prefix, and a FFT size for the target BS.

48. The computer-program product of claim 43, wherein configuration information is contained as a TLV in the transmitted message.

49. The computer-program product of claim 43, wherein configuration information is contained in a BS re-direct MAC management message.

50. A computer-program product for performing network acquisition by a mobile station (MS), comprising a computer readable medium having instructions stored thereon, the instructions being executable by one or more processors and the instructions comprising:
instructions for receiving a message, from a current BS, redirecting the MS to perform network acquisition with a target BS;
instructions for extracting configuration information for the target BS from the message; and
instructions for performing network acquisition with the target BS using the configuration information for the neighbor BS extracted from the message.

51. The computer-program product of claim 50, wherein the message is received during a network entry procedure with the current BS.

52. The computer-program product of claim 50, wherein the message is received after successful network entry with the current BS.

53. The computer-program product of claim 50, wherein the configuration information comprises information allowing the MS to communicate with the target BS without scanning for a preamble.

54. The computer-program product of claim 50, wherein the configuration information comprises at least one of: a frequency index, a preamble index, a cyclic prefix, and a FFT size for the target BS.

55. The computer-program product of claim 50, wherein configuration information is contained as a TLV in the transmitted message.

56. The computer-program product of claim 50, wherein configuration information is contained in a BS re-direct MAC management message.
